(19) United States
(12) Patent Application Publication
(10) Pub. No.: US 2020/0097867 A1
(43) Pub. Date: Mar. 26, 2020

(54) VISUALIZATION OF CROSS-PROJECT DEPENDENCY RISK

(71) Applicant: International Business Machines Corporation, Armonk, NY (US)

(72) Inventors: Gerhardt J. Scriven, Indaiatuba (BR); Marcos B. P. Cesar, Sao Paulo (BR); Thiago C. Rotta, Campinas (BR)

(21) Appl. No.: 16/139,919

(22) Filed: Sep. 24, 2018

(51) Int. Cl. G06Q 10/06; G06T 11/20

(52) U.S. Cl. CPC G06Q 10/0635; G06F 17/27; G06T 11/206; G06Q 10/06313

(57) ABSTRACT

Managing cross-project dependencies is provided. A list of Information Technology (IT) projects and their corresponding dependent IT projects is generated. A cross-project dependency risk chart having an X-axis based on IT project release dates and a Y-axis based on IT project positions is generated. Each IT project, along with its corresponding set of dependent IT projects from the list, is plotted on the X-axis of the cross-project dependency risk chart based on determined project release dates and on the Y-axis of the cross-project dependency risk chart based on determined project positions. A line representing cross-project dependency is inserted between each dependent IT project and an IT project that a respective dependent IT project depends on with an arrow pointing to the IT project that the respective dependent IT project depends on. The cross-project dependency risk chart is outputted on a display device.

### BACKGROUND

### 1. Field

The disclosure relates generally to project management and more specifically to identifying cross-project dependencies, analyzing a risk of failing to meet one or more project release dates based on the cross-project dependencies, and generating a visualization of the project release date risk in a cross-project dependency risk chart.

### 2. Description of the Related Art

A project is a temporary endeavor designed to produce a unique product, service, or result with a defined beginning and end, which is usually constrained by scope, time, quality, and budget, undertaken to meet unique goals and objectives to bring about beneficial change or added value. This information is usually described in project documentation, created at the beginning of the project development process. Project development is the systematic use of resources, knowledge, and practices to design and implement a given project and meet its goals and objectives within the specified constraints. Project development is widely used in Information Technology (IT) projects. IT is the use of computers and other data processing systems to store, retrieve, transmit, and manipulate data, often in the context of an enterprise or business.

IT project management is the process of planning, organizing, and delineating responsibility for the completion of an enterprise's specific IT goals. IT project management includes overseeing projects for software development, hardware installations, network upgrades, cloud computing rollouts, business analytics, data management, IT service implementation, and the like. In addition to normal issues that can cause a project to fail, factors that can negatively affect the success of an IT project may include advances in technology during the project's execution, infrastructure changes that impact security and data management, and unknown dependent relationships among hardware, software, network infrastructure, and data.

### SUMMARY

According to one illustrative embodiment, a computer-implemented method for managing cross-project dependencies is provided. A computer generates a list of Information Technology (IT) projects and their corresponding dependent IT projects. The computer generates a cross-project dependency risk chart having an X-axis based on IT project release dates and a Y-axis based on IT project positions. The computer plots each IT project, along with its corresponding set of dependent IT projects from the list, on the X-axis of the cross-project dependency risk chart based on determined project release dates and on the Y-axis of the cross-project dependency risk chart based on determined project positions. The computer inserts a line representing cross-project dependency between each dependent IT project and an IT project that a respective dependent IT project depends on with an arrow pointing to the IT project that the respective dependent IT project depends on. The computer outputs the cross-project dependency risk chart on a display device. According to other illustrative embodiments, a computer system and computer program product for managing cross-project dependencies are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a cross-project dependency risk chart in accordance with an illustrative embodiment;

FIG. 4 is a diagram illustrating an example of project dependencies and related project metadata in accordance with an illustrative embodiment;

FIG. 5 is a diagram illustrating an example of project data and dependency risk-related metadata in accordance with an illustrative embodiment;

FIGS. 6A-6C are a flowchart illustrating a process for generating a cross-project dependency risk chart in accordance with an illustrative embodiment;

FIG. 7 is a flowchart illustrating a process for outputting a secondary project dependency chart in accordance with an illustrative embodiment; and

FIG. 8 is a flowchart illustrating a process for modifying a cross-project dependency risk chart in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

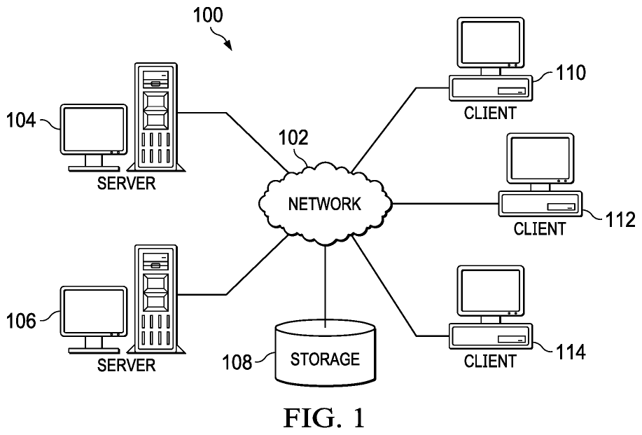

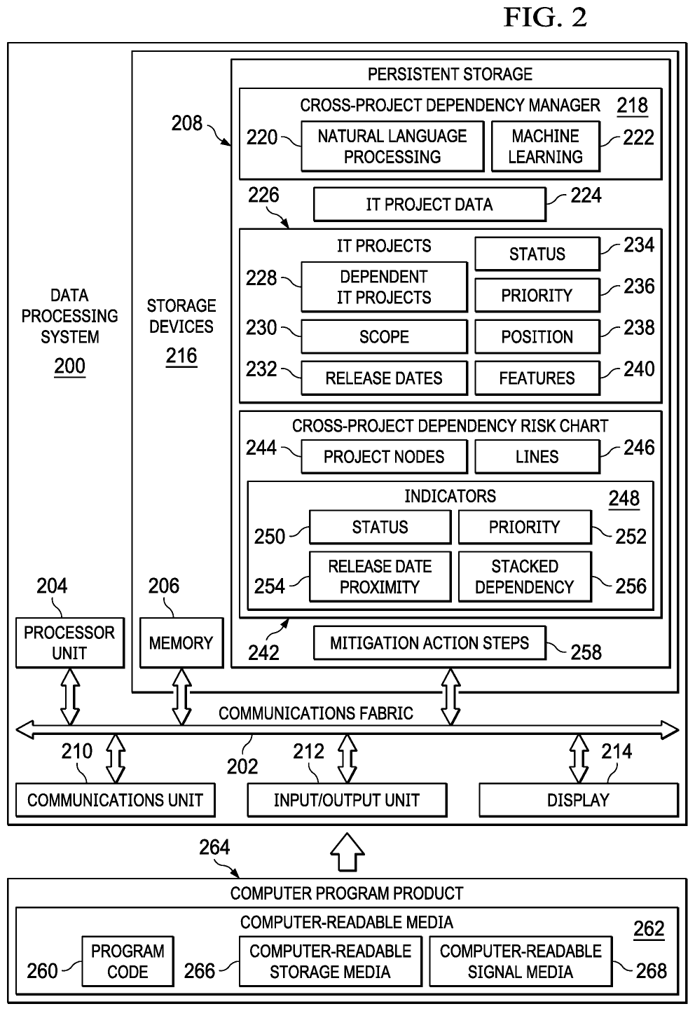

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 provide a set of services to registered client devices for managing risk corresponding to Information Technology (IT) cross-project dependencies. Further, server 104 and server 106 may each represent a cluster of servers in a data center. Alternatively, server 104 and server 106 may represent computing nodes in a cloud environment that provides IT cross-project dependency risk management services.

Client 110, client 112, and client 114 also connect to network 102. Clients 110, 112, and 114 are registered clients of server 104 and server 106. In this example, clients 110, 112, and 114 are illustrated as desktop or personal computers with wire communication links to network 102. However, it should be noted that clients 110, 112, and 114 are meant as examples only. In other words, clients 110, 112, and 114 may include other types of data processing systems, such as, for example, network computers, laptop computers, handheld computers, smart phones, smart watches, smart televisions, and the like, with wire or wireless communication links to network 102.

Users of clients 110, 112, and 114 may utilize clients 110, 112, and 114 to access and utilize the IT cross-project dependency risk management services hosted by server 104 and server 106. For example, server 104 and server 106 analyze raw IT project data corresponding to a plurality of IT projects in the process of development using, for example, natural language processing, identify IT cross-project dependencies based on the analysis, determine a level of risk associated with failing to meet one or more IT project release dates based on the identified cross-project dependencies using, for example, machine learning, generate a chart that visualizes the level of release date risk corresponding to dependent IT projects, and display the IT cross-project dependency risk chart on requesting client devices. Further, server 104 and server 106 may automatically perform one or more action steps to mitigate an impact of an IT project, which has one or more dependent IT projects, missing a set release date.

Storage 108 is a network storage device capable of storing any type of data in a structured format or an unstructured format. In addition, storage 108 may represent a plurality of different network storage devices located locally to server 104 and server 106 and/or located remotely. Further, storage 108 may store identifiers and IP addresses for a plurality of client devices; identifiers for a plurality of client device users; raw IT project data corresponding to one or more enterprises; lists of current IT projects and their corresponding dependent IT projects; IT project release dates, a plurality of different cross-project dependency risk charts, and the like. Furthermore, storage unit 108 may store authentication or credential data that may include user names, passwords, and biometric data associated with system administrators and client device users, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), or any combination thereof. FIG. 1 is intended as an example only, and not as an architectural limitation for the different illustrative embodiments.

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random-access memory, or any other suitable volatile or non-volatile storage device. Persistent storage 208 may take various forms, depending on the particular implementation.

In this example, persistent storage 208 stores cross-project dependency manager 218. However, it should be noted that even though cross-project dependency manager 218 is illustrated as residing in persistent storage 208, in an alternative illustrative embodiment cross-project dependency manager 218 may be a separate component of data processing system 200. For example, cross-project dependency manager 218 may be a hardware component coupled to communication fabric 202 or a combination of hardware and software components. In another alternative illustrative embodiment, a first portion of cross-project dependency manager 218 may be located in data processing system 200 and a second portion of cross-project dependency manager 218 may be located in a second data processing system, such as client 110 in FIG. 1. In yet another alternative illustrative embodiment, cross-project dependency manager 218 may be located in client devices in addition to, or instead of, data processing system 200.

Cross-project dependency manager 218 controls the process of managing IT project dependencies for an enterprise. For example, cross-project dependency manager 218 utilizes natural language processing 220 and machine learning 222 to analyze IT project data 224. Cross-project dependency manager 218 may retrieve IT project data 224 from one or more IT project data sources, such as storage 108 in FIG. 1. IT project data 224 represent raw information corresponding to a plurality of IT projects, such as IT projects 226, in current development by the enterprise. However, it should be noted that IT project data 224 may represent IT project data for a plurality of different enterprises.

Cross-project dependency manager 218 utilizes natural language processing 220 and machine learning 222 to identify dependent IT projects 228 of one or more IT projects in IT projects 226 based on the analysis of IT project data 224. A dependent IT project is an IT project that needs one or more features or technical assets of another IT project currently under development. In other words, an IT project dependency is a reliance on another particular IT project being completed first to provide the needed functionality in the dependent IT project.

Cross-project dependency manager 218 also utilizes natural language processing 220 and machine learning 222 to identify scope 230, release dates 232, status 234, priority 236, position 238, and features 240 corresponding to each IT project in IT projects 226 and dependent IT projects 228 based on the analysis of IT project data 224. It should be noted that illustrative embodiments employ standard supervised and unsupervised techniques to extract needed structural information from unstructured data. Also, training data may come from structured or unstructured data sources. Scope 230 represents specific business centric, goals, such as, for example, deliverables, tasks, costs, deadlines, and the like, corresponding to each particular IT project. Release dates 232 represent specified time periods for completing each particular IT project. Release dates 232 may be in terms of a day, a week, or a month, for example. Status 234 indicates whether each particular IT project is on target to meet its corresponding release date and, therefore, indicative of a project's overall health. Priority 236 is a level of business importance that the enterprise assigns to each particular IT project. Business priority and time to market are driving factors, which in most cases, add pressure to IT planning. Position 238 represents a rank or location of a particular IT project in a series of IT projects with project dependencies. Cross-project dependency manager 218 utilizes position 238 to prevent overlap of IT projects in the Y-axis (i.e., vertical axis) of cross-project dependency risk chart 242. For example, cross-project dependency manager 218 may position an IT project having a higher rank in a series of IT projects at the top of cross-project dependency risk chart 242 and position a lower ranking IT project in the series at the bottom of cross-project dependency risk chart 242 or vice versa. Features 240 represent a set of one or more characteristics, attributes, or functions that are to be achieved in each particular IT project. In other words, these features depict those constructs that the particular IT project provides and that the dependent IT projects are dependent on.

Cross-project dependency manager 218 generates cross-project dependency risk chart 242 based on identification of IT projects 226 and dependent IT projects 228 and their corresponding release dates 232, status 234, priority 236, position 238, and features 240. Cross-project dependency risk chart 242 provides a visualization of the level of risk corresponding to different IT projects not making their specified release dates. Cross-project dependency risk chart 242 includes project nodes 244, lines 246, and indicators 248.

Each node in project nodes 244 represents a particular IT project. Lines 246 represent edges between nodes indicating IT project dependencies. In addition, lines 246 include arrows that point from a dependent IT project to an IT project that the dependent IT project has a dependency on. Indicators 248 include status 250, priority 252, release date proximity 254, and stacked dependency 256.

Cross-project dependency manager 218 applies status 250 and priority 252 to each node that corresponds to an IT project. Status 250 indicates a current status of a particular IT project and may be color-coded, such as a green, yellow, and red status indicator. For example, a green indicator may signify a “go” project status, a yellow indicator may signify a “caution” project status, and a red indicator may signify a “stopped, stalled, or delayed” project status. Priority 252 indicates a current level of priority assigned by the enterprise to each particular IT project and may also be color-coded, such as a gold, silver, and bronze project priority indicator. For example, a gold indicator may signify a “critical or high-level” project priority, a silver indicator may signify an “average or mid-level” project priority, and a bronze indicator may signify a “low-level” project priority.

Cross-project dependency manager 218 applies release date proximity 254 to each line in lines 246. Release date proximity 254 indicates how close in time (i.e., closeness of release dates) a dependent IT project is to the IT project that it depends on and may also be color-coded, such as a green, yellow, and red release date proximity indicator. For example, a green indicator may signify that a dependent project's scheduled release date is at least two or more release date time periods away from the IT project it depends on, a yellow indicator may signify that a dependent project's scheduled release date is one release date time period away from the IT project it depends on, and a red indicator may signify that a dependent project's scheduled release date is in a same release date time period as the IT project it depends on.

Cross-project dependency manager 218 applies stacked dependency 256 only to those dependent IT projects that have more than one dependency (i.e., multiple project dependencies). For example, if IT project A is dependent on IT project B and IT project B is dependent on IT project C, then cross-project dependency manager 218 applies stacked dependency 256 to IT project A based on the multiple dependencies.

Conversely, if IT project A is dependent on both IT projects B and C, then cross-project dependency manager 218 similarly applies stacked dependency 256 to IT project A based on the multiple parallel dependencies. Cross-project dependency manager 218 may indicate stacked dependency 256 by, for example, applying a number of rings surrounding a node, which corresponds to the dependent IT project, equal to the number of dependencies.

After generating cross-project dependency risk chart 242, cross-project dependency manager 218 displays cross-project dependency risk chart 242 on a user interface of a requesting client device. Moreover, cross-project dependency manager 218, using machine learning 222, may determine that one or more IT projects may not meet their specified release dates by, for example, extrapolating project historical status values and comparing to historical behavior of projects that miss release dates and automatically perform mitigation action steps 258. Mitigation action steps 258 represent a set of one or more action steps to mitigate (i.e., lessen or eliminate) an impact of missing IT project release dates. Mitigation action steps 258 may include, for example, sending an alert message to the user of the requesting client device identifying which particular IT projects are at risk of not meeting scheduled release dates for review and possible action. Mitigation action steps 258 also may include cross-project dependency manager 218 automatically moving an at-risk IT project from one scheduled release date to another, along with any IT projects that depend on the at-risk project, and notifying select users (e.g., IT project change reviewers and approvers) to contest changes.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra-high frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 260 is located in a functional form on computer readable media 262 that is selectively removable and may be loaded onto or transferred to data processing system 200 for running by processor unit 204. Program code 260 and computer readable media 262 form computer program product 264. In one example, computer readable media 262 may be computer readable storage media 266 or computer readable signal media 268. Computer readable storage media 266 may include, for example, an optical or magnetic disc that is inserted or placed into a drive or other device that is part of persistent storage 208 for transfer onto a storage device, such as a hard drive, that is part of persistent storage 208. Computer readable storage media 266 also may take the form of a persistent storage, such as a hard drive, a thumb drive, or a flash memory that is connected to data processing system 200. In some instances, computer readable storage media 266 may not be removable from data processing system 200.

Alternatively, program code 260 may be transferred to data processing system 200 using computer readable signal media 268. Computer readable signal media 268 may be, for example, a propagated data signal containing program code 260. For example, computer readable signal media 268 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 260 may be downloaded over a network to persistent storage 208 from another device or data processing system through computer readable signal media 268 for use within data processing system 200. For instance, program code stored in a computer readable storage media in a data processing system may be downloaded over a network from the data processing system to data processing system 200. The data processing system providing program code 260 may be a server computer, a client computer, or some other device capable of storing and transmitting program code 260.

The different components illustrated for data processing system 200 are not meant to provide architectural limitations to the manner in which different embodiments may be implemented. The different illustrative embodiments may be implemented in a data processing system by including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 266 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Large-scale IT project development brings many challenges to dependency management. In large enterprises, at any given point in time, there may be hundreds of IT projects running concurrently and in various phases of their development life cycles. Considering that a single enterprise architecture model is usually prescribed, it frequently happens that any given IT project has one or more dependencies on other IT projects that are also being developed at the same time for performing a discreet amount of work that the dependent project can exploit (e.g., reuse as-is or extend) and in the process achieve reuse of existing code and other technical assets, which has short and long-term benefits. Logically, the one or more IT projects that are providing the functionality that will be reused or extended by the dependent IT project should be ahead in their life cycles as compared to the dependent IT project life cycle. When this is not the case (i.e., when two or more IT projects target the same release time period (e.g., same month)), the project dependency becomes a risk as issues or errors in the requirements, architectural design, or code of the one or more IT projects that are providing the shared technical assets may hold up the development of extensions or pre-production testing of the dependent IT project. Moreover, it is found in practice that IT projects sometime run into trouble, miss deployment dates, or split into child IT projects to spread the delivery of certain features.

In a complex IT environment, such as where 200 or more IT projects with IT impact are concurrently being developed, with fixed release time windows in place, solutions do not currently exist that roll up to the executive level and highlight risk associated with cross-project dependencies. This cross-project dependency analysis is important when needing to make executive decisions as to which IT projects to place on hold or cancel based on budget constraints, when IT projects need to move from one release date to another, or when coming off a hold status, for example. This issue is exacerbated when different IT projects roll up to different departments within a large enterprise and no one single IT project executive exists to oversee all IT projects within the enterprise. Adding complexity to this issue is that no one software developer or software development team can anticipate or know all IT project dependencies, different software development teams may have conflicting priorities across their IT project backlogs, IT project scope is dynamic so project dependency management is ongoing, and with shortened release times, less time exists to coordinate IT project development.

Lack of solutions that can highlight cross-project dependency risk and can be easily reviewed by executive decision makers hampers large enterprises from making meaningful decisions as to when to maximize their investment as a function of time. For example, when project dependencies are not met, the dependent project can be negatively affected and, therefore, a product's roadmap. For example, a product's roadmap may include a series of several project releases, which may include one or more dependent projects. Often, by the time it is discovered that a project, which a dependent project depends on, will not deliver the set of features that the dependent project needs, it is too late to make an adjustment to stay on track for the dependent project's original release date, which negatively impacts the enterprise's return on investment.

Illustrative embodiments provide an automated, technical solution to cross-project dependency analysis and visualization. Illustrative embodiments by displaying, within a single enterprise view, those IT projects on which other IT projects are dependent on as a function of release dates, together with their respective enterprise priorities, highlight risk based on proximity of release dates and risk associated with project dependency stacking. For example, if IT project A depends on IT project B and IT project B depends on IT project C, then illustrative embodiments determine and show that IT project A has a double dependency and is doubly at risk. In addition, illustrative embodiments are able to highlight which specific set of features a dependent project is dependent upon so that executive decision makers can determine cause and effect on the IT project ecosystem when needing to make decisions regarding placing IT projects on hold, cancelling IT projects, or approving movement of IT projects from one release date to another.

Further, illustrative embodiments provide a cross-project dependency risk chart that allows for real-time “what-if scenario” results. What-if scenarios allow executive decision makers to look at the impact of moving release dates of one or more IT projects. One possible reason for moving release dates may have little to do with IT project dependency management and more to do with budget constraints that drive executives to make such decisions. The cross-project dependency risk chart enables these executive decision makers to understand in real-time the collateral impact of moving IT project release dates. Furthermore, by a user selecting an IT project that has one or more dependencies within the cross-project dependency risk chart, illustrative embodiments display a secondary chart that focuses only on that particular IT project, showing a more granular set of details regarding the dependencies corresponding to that particular IT project, the scope of that particular IT project that drives the need, the set of features that will be reused, any optional alternative strategies, and test scenarios that ensure that the shared set of features fulfills the dependent IT project's needs. As a result, illustrative embodiments act as an early warning system identifying where highest project release date risk lies for an enterprise in terms of inter-project dependencies so that executive decision makers can create mitigation strategies for at-risk dependent projects.

Illustrative embodiments can capture raw IT project dependency data from project artifacts stored in one or more IT project databases. Similarly, illustrative embodiments may capture IT project status (e.g., green, yellow, or red project status) and enterprise priority (e.g., gold, silver, or bronze priority) from receiving input from users, such as IT project managers, and/or identifying similar IT projects. Illustrative embodiments then load the full IT project dataset into one database and use natural language processing and machine learning, for example, to assist with identifying how many dependencies (e.g., on a particular feature) each IT project carries. Illustrative embodiments plot the results of the analysis on a cross-project dependency risk chart electronically.

Moreover, illustrative embodiments may utilize cognitive machine learning to perform the gathering of the raw IT project data by giving the cognitive machine learning model access to those systems that store IT project metadata, such as release dates, project status, and the like. Because IT projects, along with the scope that these IT projects address per release time period, and their IT project dependencies are dynamic in large enterprises, illustrative embodiments generate the cross-project dependency risk chart on a regular time interval basis, such as, for example, weekly or daily, to show the current state of cross-project dependency risk.

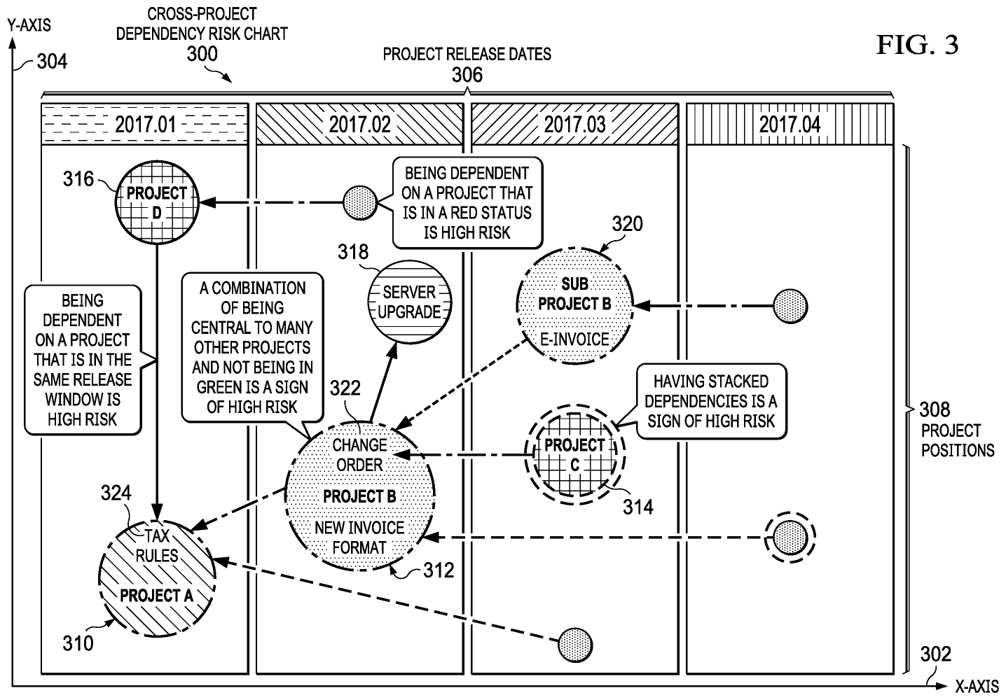

With reference now to FIG. 3, a diagram illustrating an example of a cross-project dependency risk chart is depicted in accordance with an illustrative embodiment. Cross-project dependency risk chart 300 may be, for example, cross-project dependency risk chart 242 in FIG. 2. Cross-project dependency risk chart 300 shows dependencies between different IT projects in a plurality of IT projects currently under development by an enterprise and also illustrates the level of risk corresponding to different IT projects not making their corresponding project release dates. It should be noted that even though cross-project dependency risk chart 300 only shows ten IT projects currently under development, cross-project dependency risk chart 300 may show any number of IT projects, such as hundreds of IT projects along with their respective dependencies. In other words, cross-project dependency risk chart 300 is only meant as an example and not as a limitation on illustrative embodiments.

Cross-project dependency risk chart 300 includes X-axis 302 and Y-axis 304. X-axis 302 is based on project release dates 306, such as release dates 232 corresponding to IT projects 226 in FIG. 2. Y-axis 304 is based on project positions 308, such as position 238 corresponding to different IT projects in IP projects 226 in FIG. 2.

Illustrative embodiments plot each IT project on cross-project dependency risk chart 300 based on respective release dates (e.g., year/month) using a project node or container, such as, for example, a circular shape, and listing each project's unique identifier within the project node. In addition, illustrative embodiments show inter-project dependencies among the IT projects by connecting the nodes representing the IT projects with lines having an arrow pointing to the IT project that another IT project depends on for one or more features or technical assets. Also, it should be noted that illustrative embodiments may display only a portion of cross-project dependency risk chart 300 by, for example, only showing those IT projects that form part of a certain software product range based on user selection. User input drives such filters where the filters are unique and meaningful to the specific enterprise.

Further, illustrative embodiments insert text inside IT project nodes listing particular features (e.g., by listing unique feature identifiers or brief feature descriptions) that a dependent IT project is dependent on and orient the line that connects the two IT projects to point to a particular feature within the corresponding IT project node that will provide that particular feature. Thus, illustrative embodiments allow a user to better visualize and pinpoint the effect on other IT projects when a specific feature is removed from a particular IT project.

In this example, cross-project dependency risk chart 300 includes a project node for IT Project A 310, IT Project B 312, IT Project C 314, IT Project D 316, IT Project Server Upgrade 318, IT Sub-Project B 320, and four other IT projects. Also in this example, IT Project C 314 is dependent on feature “Change Order” 322, which will be provided by IT Project B 312. It should be noted that when illustrative embodiments do not list specific feature details in an IT project node, such as the project node for IT Project Server Upgrade 318, that particular IT project needs to delivered in its entirety to satisfy the scope or feature requirements of the dependent IT project, such as IT Project B 312.

Further, the size of each IT project node reflects how many other IT projects are dependent on it. Thus, the larger the size of a node, the more critical it is to ensure success of that particular IT project corresponding to that node due to other IT project dependencies on that particular IT project. For example, IT Project B 312 is shown much larger than other IT projects because of the number of IT projects that depend on it. In addition, even though the node corresponding to IT Project B 312 only includes a mid-level project priority indicator, from a business point of view (i.e., high-level business priority), IT Project B 312 is critical for the success of the IT projects that depend on IT Project B 312. Project priority indicators may be, for example, a gold high-level project priority indicator, a silver mid-level project priority indicator, and a bronze low-level project priority indicator.

Furthermore, a project status indicator located on a border of a project node indicates a current project status. Project status indicators may be, for example, a “go” green project status indicator, a “caution” yellow project status indicator, and a “stopped or delayed” red project status indicator. A project node with a stopped or delayed project status indicator (e.g., red) on its border and its corresponding IT project has other IT projects dependent on it, this constitutes a high level of risk to the enterprise. For example, the node corresponding to IT Project D 316 includes a high-level project priority indicator (e.g., gold) and, therefore, critical to the enterprise. However, the border of the node for IT Project D 316 includes a stopped or delayed project status indicator (e.g., red) signifying that IT Project D 316 is at high risk of not making the 2017.01 project release date.

Illustrative embodiments apply a release date proximity indicator, which signifies closeness of IT project release date risk, to lines between IT project nodes. The release date proximity indicator also may be color-coded (e.g., green, yellow, or red). For example, when the release dates of two IT projects are close (i.e., within the same release date time period), then the release date proximity indicator will signify a higher risk (e.g., red). When two IT projects have release dates that are further apart, the release date proximity indicator will signify a lower risk (e.g., yellow or green). Illustrative embodiments provide a description of an IT project dependency, consequences of the dependency not panning out, and one or more mitigation strategies in response to receive a user input, such as a user hovering a mouse cursor over a particular line.

In this example, the node corresponding to IT Project D 316 includes a high-level project priority indicator (e.g., gold) and a stopped or delayed status indicator (e.g., red). In addition, IT Project D 316 has a critical dependency on feature “Tax Rules” 324 that will be provided by IT Project A 310, which carries a low-level priority status (e.g., bronze) signifying that IT Project A 310 is not as high a business priority as other IT projects. The added level of risk in this example is that both IT Project D 316 and IT Project A 310 are targeted for the same release time period (2017.01). For example, defects that are discovered in pre-production testing for IT Project A 310 may hold up pre-production testing of IT Project D 316.

Moreover, illustrative embodiments also show stacked IT project dependencies using a stacked dependency indicator. An IT project that has multiple dependencies carries more risk that an IT project that has only a single dependency. Moreover, a dependent IT project that is part of a chain of other dependent projects similarly constitutes a high level of risk. For example, the node corresponding to IT Project C 314 carries a “go” project status indicator (e.g., green) and a high-level project priority indicator (e.g., gold) and IT Project C 314 has a feature dependency on IT Project B 312, which in turn has a feature dependency on IT Project A 310. Both nodes corresponding to IT Project A 310 and IT Project B 312 include a “caution” project status indicator (e.g., yellow) and neither IT Project A 310 having a low-level project priority indicator nor IT Project B 312 having a mid-level project priority indicator is regarded as important to the enterprise as IT Project C 314 having a high-level project priority indicator. This constitutes a high level of risk to the enterprise.

The project priority indicators allow a user to visually gauge IT constraints compared to what an enterprise determines to be top IT project priorities. Simply because an enterprise carries a certain view of prioritizing IT projects and resources (e.g., funding), success is not guaranteed because these IT projects may be at risk due to project dependencies that were locked in when the IT projects were originally solutioned. Hence, illustrative embodiments allow a user to easily view the bigger picture and can assist in making trade-off decisions.

Moreover, illustrative embodiments allow creation of real-time what-if scenarios. For example, if IT Project D 316 moves from the 2017.01 release date time period to the 2017.02 release date time period by a user moving the node representing IT Project D 316 to the 2017.02 box, then it is clear that not many other IT projects will be impacted by the move. However, a more critical dependency will exist between IT Project D 316 and the IT project that is shown to be dependent on it as the two projects will now fall in the same release date time period (i.e., 2017.02). On the other hand, if IT Project A 310 moves to the 2017.02 release date time period, then the level of risk will be higher. For example, IT Project D 316, which is in the 2017.01 release time period, currently shows a feature dependency on IT Project A 310. As a result, IT Project D 316 will either need to move to the 2017.02 release date time period as well or the project development team for IT Project D 316 will have to build the code for feature “Tax Rules” 324 themselves, effectively duplicating the work for IT Project A 310. Also, IT Project B 312, which is shown to be critical to the enterprise, will have a same release date dependency on IT Project A 310, which constitutes a high-level of risk to the enterprise.

In certain cases, a project development team may not be able to deliver all of the scope or features of a particular IT project that the team committed to for a specific release date time period. Rather than moving the undelivered scope or features over to another IT project, that particular IT project may not be closed out entirely and delivery of that scope or features may be moved to a next release date time period. For example, the occurrence of IT Sub-Project B 320 in the 2017.03 release date time period allows for a subset of the scope or features (i.e., feature “E-Invoice”) from IT Project B 312 to be delivered late. Even though illustrative embodiments are logically connecting the 2017.02 release date time period and the 2017.03 release time period for IT Project B 312 and IT Sub-Project B 320, this does not create a cross-project dependency, which is indicated by the dashed line.

Also, another type of IT project dependency is shown in the 2017.02 release date time period. This type of IT project dependency is a server upgrade, which IT Project B 312 depends on. While not strictly a cross-project dependency, system environmental changes, such as, for example, hardware upgrades, are critical for IT project success. As a result, illustrative embodiments specifically call out these types of changes in cross-project dependency risk chart 300. The fact that IT Project B 312 is dependent on IT Project Server Upgrade 318 within the same release date time period (i.e., 2017.01) in which the server upgrade is scheduled, this constitutes a high level of risk to the enterprise.

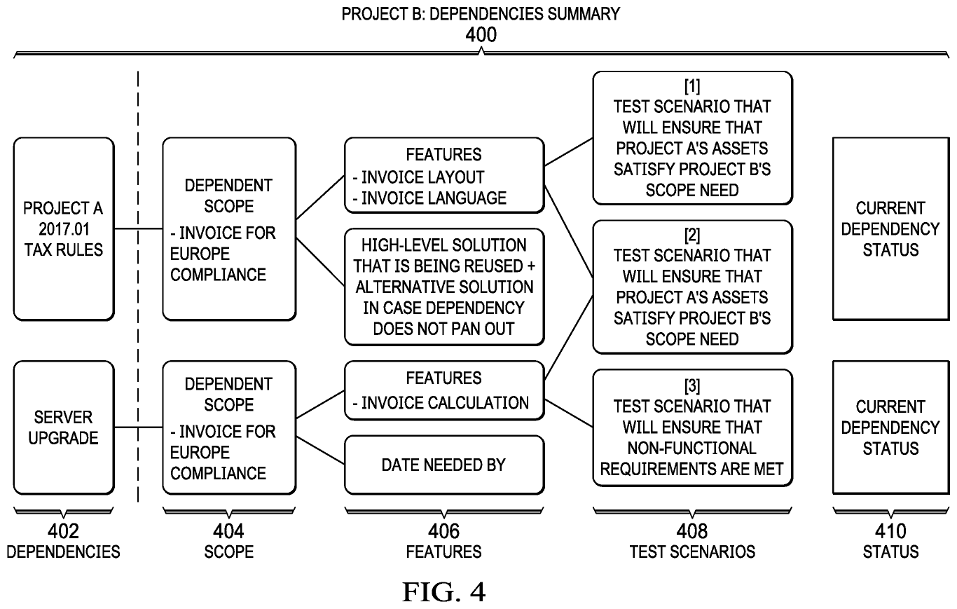

With reference now to FIG. 4, a diagram illustrating an example of project dependencies and related project metadata is depicted in accordance with an illustrative embodiment. IT Project B dependency summary 400 is an example of a secondary project dependency chart, which illustrative embodiments generate from a cross-project dependency risk chart, such as cross-project dependency risk chart 300 in FIG. 3.

Illustrative embodiments generate IT Project B dependency summary 400 when a user selects a particular IT project, such as IT Project B 312 in FIG. 3, which has one or more dependencies. As a result of the user selecting that particular IT project, illustrative embodiments generate the secondary project dependency chart, which focuses in greater detail on that particular IT project (i.e., IT Project B in this example). In this example, IT Project B dependency summary 400 includes details such as dependencies 402, scope 404, features 406, test scenarios 408, and status 410.

Dependencies 402 represent the feature dependencies of IT Project B, which are the tax rules feature that will be provided by IT Project A, such as IT Project A 310 in FIG. 3, and the server upgrade feature that will be provided by IT Project Server Upgrade, such as IT Project Server Upgrade 318 in FIG. 3. Scope 404 shows details of the project scope that is being satisfied by the other IT projects. Features 406 show the specific features/business requirements that derive from scope 404 and a high-level overview of the solution that is being reused, together with an alternative solution approach in case the dependency does not pan out. Test scenarios 408 show test scenarios that will ensure that the solution indeed addresses scope 404. Status 410 shows the current dependency status of each dependency. It should be noted that, a user can add other specific details (e.g., impacted IT applications or business processes as part of the high-level solution, requirement numbers with the features, and the like) to boxes as deemed necessary by a particular enterprise.

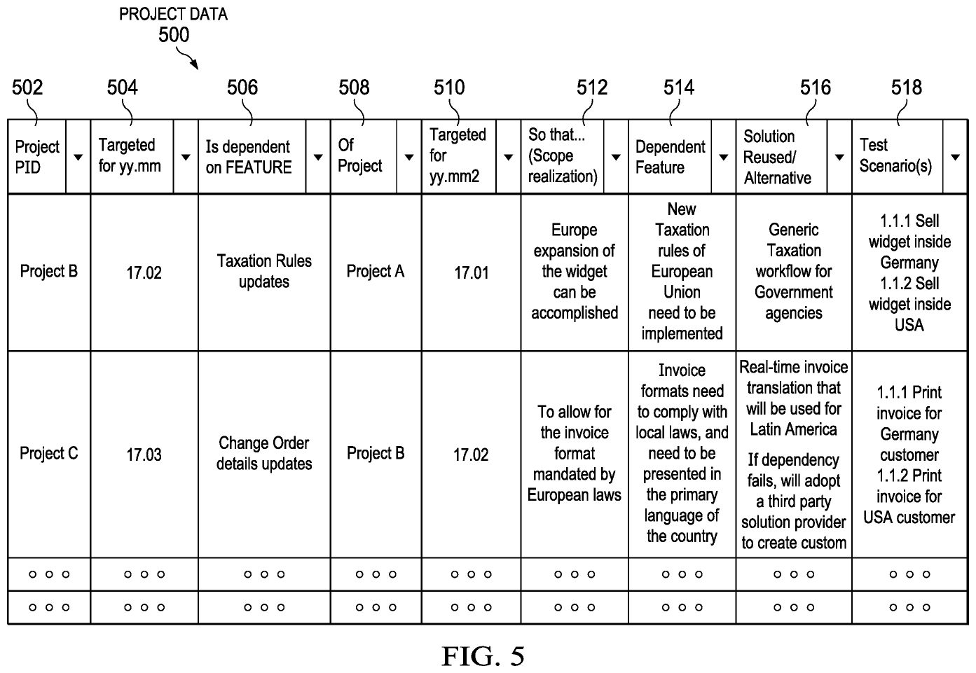

With reference now to FIG. 5, a diagram illustrating an example of project data and dependency risk-related metadata is depicted in accordance with an illustrative embodiment. Project data 500 may be, for example, IT project data 224 in FIG. 2. Project data 500 represent raw data regarding a plurality of IT projects corresponding to an enterprise.

In this example, project data 500 include project PID 502, targeted for yy.mm 504, is dependent on Feature 506, of Project 508, targeted for yy.mm2 510, so that (Scope realization) 512, Dependent Feature 514, Solution Reused/Alternative 516, and Test Scenario(s) 518. For example, IT Project B is targeted for the 2017.02 release date time period and is dependent on feature tax rules of IT Project A, which is targeted for the 2017.01 release date time period, so that European expansion of a widget can be accomplished. As a result, a dependent feature of new tax rules of the European Union needs to be implemented. A solution to be reused is a generic taxation workflow for government agencies. Test scenario 1.1.1 is sell the widget inside a country that is part of the European Union and test scenario 1.1.2 is sell the widget inside the country of origin.

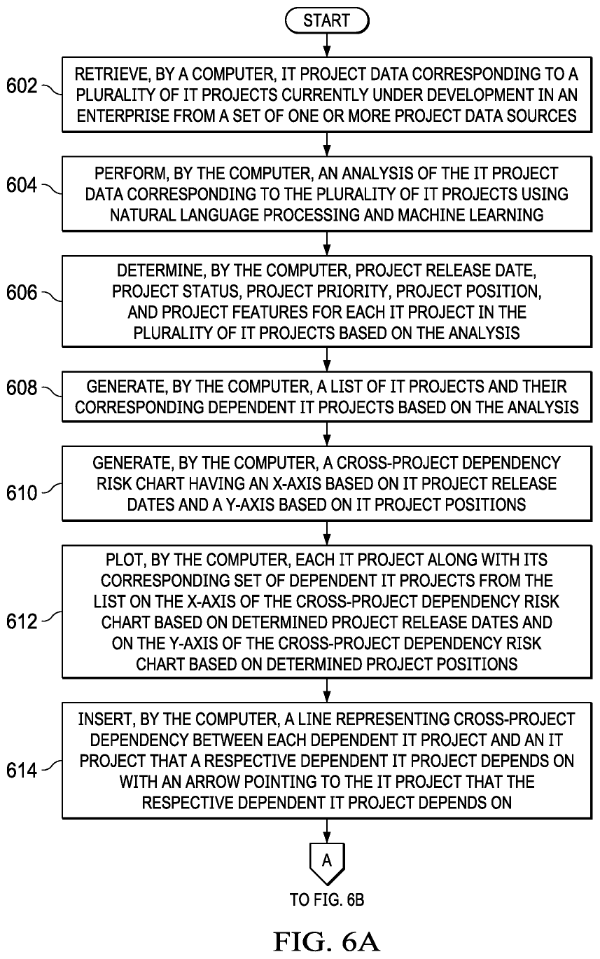

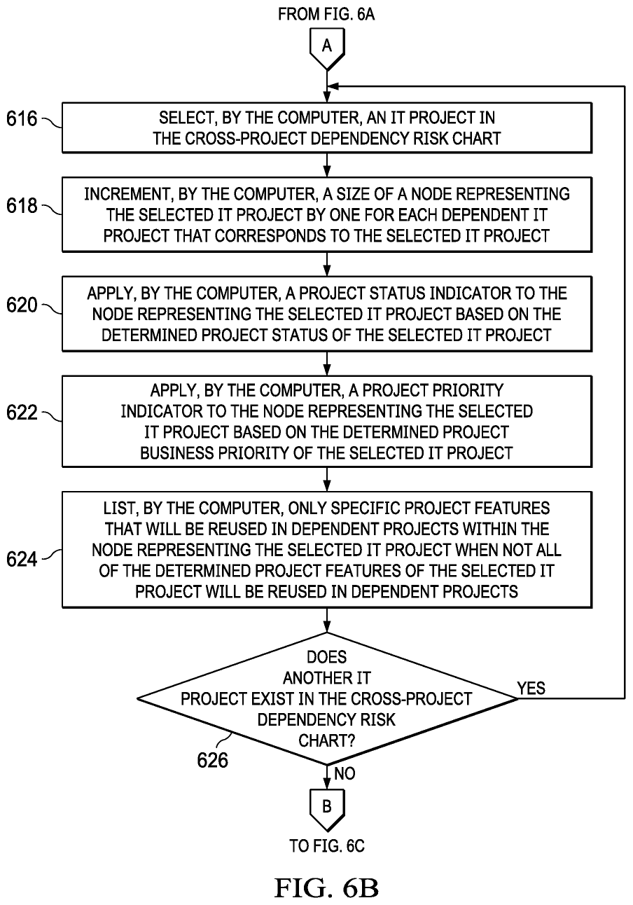

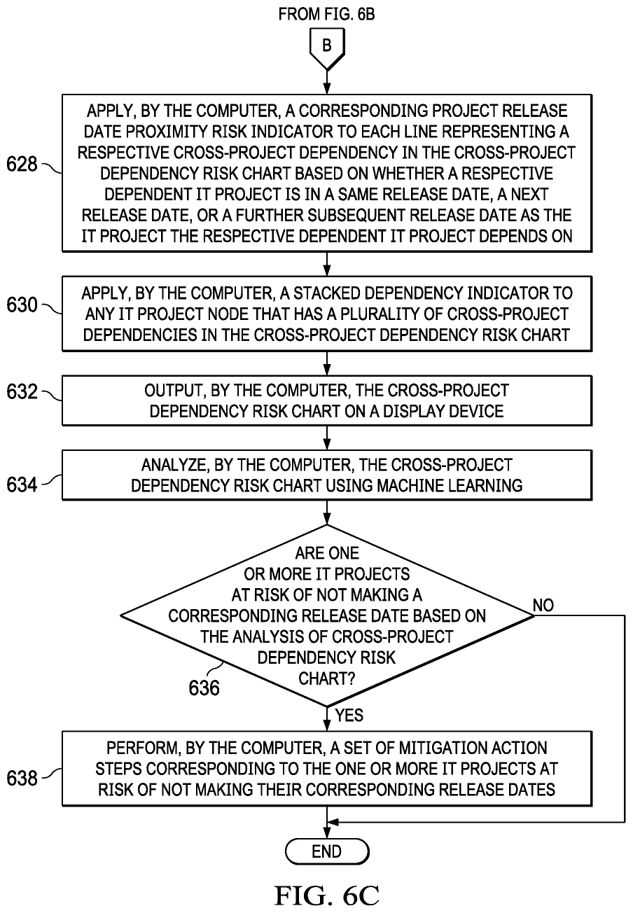

With reference now to FIGS. 6A-6C, a flowchart illustrating a process for generating a cross-project dependency risk chart is shown in accordance with an illustrative embodiment. The process shown in FIGS. 6A-6C may be implemented in a computer, such as, for example, server 104 in FIG. 1 or data processing system 200 in FIG. 2.

The process begins when the computer retrieves IT project data corresponding to a plurality of IT projects currently under development in an enterprise from a set of one or more project data sources (step 602). The computer performs an analysis of the IT project data corresponding to the plurality of IT projects using natural language processing and machine learning (step 604). It should be noted that specific details of the analysis are not described herewith because specific analysis techniques may differ from enterprise to enterprise, as well as their definitions of what a “stopped or stalled” IT project means, how many stacked dependencies are drivers, and the like. For this reason, a machine learning solution is prescribed since historical data pertaining to such IT project parameters, such as project status, plotted as a function of time, number of dependencies, business priority, and the like, together with historical data on whether a release was met or not, can act as predictors for the current set of IT projects under analysis. In addition, the computer determines project release date, project status, project priority, project position, and project features for each IT project in the plurality of IT projects based on the analysis (step 606). Further, the computer generates a list of IT projects and their corresponding dependent IT projects based on the analysis (step 608).

Furthermore, the computer generates a cross-project dependency risk chart having an X-axis based on IT project release dates and a Y-axis based on IT project positions (step 610). Moreover, the computer plots each IT project, along with its corresponding set of dependent IT projects from the list, on the X-axis of the cross-project dependency risk chart based on determined project release dates and on the Y-axis of the cross-project dependency risk chart based on determined project positions (step 612). The computer also inserts a line representing cross-project dependency between each dependent IT project and an IT project that a respective dependent IT project depends on with an arrow pointing to the IT project that the respective dependent IT project depends on (step 614).

Afterward, the computer selects an IT project in the cross-project dependency risk chart (step 616). The computer increments a size of a node representing the selected IT project by one unit of size for each dependent IT project that corresponds to the selected IT project (step 618). The computer also applies a project status indicator to the node representing the selected IT project based on the determined project status of the selected IT project (step 620). In addition, the computer applies a project priority indicator to the node representing the selected IT project based on the determined project business priority of the selected IT project (step 622). Further, the computer lists only specific project features that will be reused in dependent projects within the node representing the selected IT project when not all of the determined project features of the selected IT project will be reused in dependent projects (step 624).

Subsequently, the computer makes a determination as to whether another IT project exists in the cross-project dependency risk chart (step 626). If the computer determines that another IT project does exist in the cross-project dependency risk chart, yes output of step 626, then the process returns to step 616 where the computer selects another IT project in the chart. If the computer determines that another IT project does not exist in the cross-project dependency risk chart, no output of step 626, then the computer applies a corresponding project release date proximity risk indicator to each line representing a respective cross-project dependency in the cross-project dependency risk chart based on whether a respective dependent IT project is in a same release date, a next release date, or a further subsequent release date as the IT project the respective dependent IT project depends on (step 628). In addition, the computer applies a stacked dependency indicator to any IT project node that has a plurality of cross-project dependencies in the cross-project dependency risk chart (step 630).

Afterward, the computer outputs the cross-project dependency risk chart on a display device (step 632). Further, the computer analyzes the cross-project dependency risk chart using machine learning (step 634). The computer makes a determination as to whether one or more IT projects are at risk of not making a corresponding release date based on the analysis of the cross-project dependency risk chart (step 636).

If the computer determines that no IT project is at risk of not making its corresponding release date based on the analysis of the cross-project dependency risk chart, no output of step 636, then the process terminates thereafter. If the computer determines that one or more IT projects are at risk of not making a corresponding release date based on the analysis of the cross-project dependency risk chart, yes output of step 636, then the computer performs a set of mitigation action steps corresponding to the one or more IT projects at risk of not making their corresponding release dates (step 638). Thereafter, the process terminates.

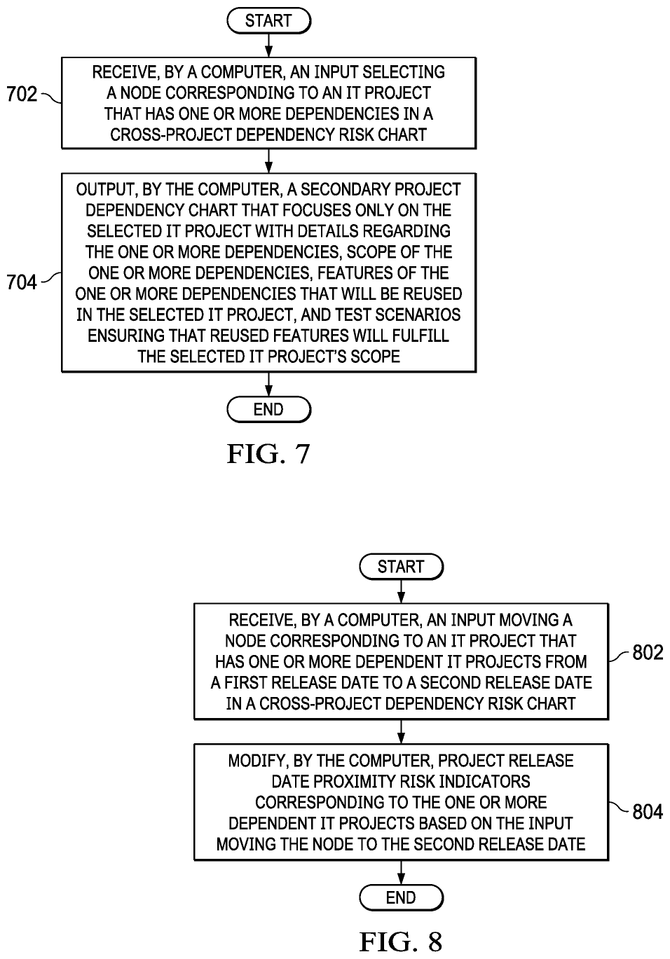

With reference now to FIG. 7, a flowchart illustrating a process for outputting a secondary project dependency chart is shown in accordance with an illustrative embodiment. The process shown in FIG. 7 may be implemented in a computer, such as, for example, server 104 in FIG. 1 or data processing system 200 in FIG. 2.

The process begins when the computer receives an input selecting a node corresponding to an IT project that has one or more dependencies in a cross-project dependency risk chart (step 702). The input may be, for example, a user input via a mouse click or voice command. In response to the computer receiving the input, the computer outputs the secondary project dependency chart that focuses only on the selected IT project with details regarding the one or more dependencies, scope of the one or more dependencies, features of the one or more dependencies that will be reused in the selected IT project, and test scenarios ensuring that reused features will fulfill the selected IT project's scope (step 704). Thereafter, the process terminates.

With reference now to FIG. 8, a flowchart illustrating a process for modifying a cross-project dependency risk chart is shown in accordance with an illustrative embodiment. The process shown in FIG. 8 may be implemented in a computer, such as, for example, server 104 in FIG. 1 or data processing system 200 in FIG. 2.

The process begins when the computer receives an input moving a node corresponding to an IT project that has one or more dependent IT projects from a first release date to a second release date, which may be earlier or later than the first release date, in a cross-project dependency risk chart (step 802). The input may be, for example, a user input via a mouse drag and drop operation or voice command. Afterward, the computer modifies project release date proximity risk indicators corresponding to the one or more dependent IT projects based on the input moving the node to the second release date (step 804). The visualization alerts the user when such a scenario will lead to an impossible situation, such as an IT project having a dependency on a project that will release on a date later than the dependent IT project's release date or other fallout scenarios such as the IT project now being dependent on another IT project that is both a red status as well as in the same release as the dependent IT project's release date. It should be noted that the scenarios mentioned are only meant as examples and are not intended to assert or imply any limitation with regard to specific rules that can be applied for governing when alerts will be triggered since such rules may vary from enterprise to enterprise. Thereafter, the process terminates.

Thus, illustrative embodiments of the present invention provide a computer-implemented method, computer system, and computer program product for identifying cross-project dependencies, analyzing a risk of failing to meet one or more project release dates based on the cross-project dependencies, and generating a visualization of the project release date risk in a cross-project dependency risk chart. As a result, illustrative embodiments provide cross-project dependency analysis on a per IT project basis and provide a visualization of this cross-project dependency analysis in a way that provides meaningful business intelligence that enterprise executives or other decision makers can act on as a function of release date. Consequently, illustrative embodiments increase a user's ability to visualize and review IT project dependency risk to make decision affecting enterprise revenue. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing cross-project dependencies, the computer-implemented method comprising:
generating, by a computer, a list of Information Technology (IT) projects and their corresponding dependent IT projects;
generating, by the computer, a cross-project dependency risk chart having an X-axis based on IT project release dates and a Y-axis based on IT project positions;
plotting, by the computer, each IT project, along with its corresponding set of dependent IT projects from the list, on the X-axis of the cross-project dependency risk chart based on determined project release dates and on the Y-axis of the cross-project dependency risk chart based on determined project positions;
inserting, by the computer, a line representing cross-project dependency between each dependent IT project and an IT project that a respective dependent IT project depends on with an arrow pointing to the IT project that the respective dependent IT project depends on; and
outputting, by the computer, the cross-project dependency risk chart on a display device.

2. The computer-implemented method of claim 1 further comprising:
retrieving, by the computer, IT project data corresponding to a plurality of IT projects currently under development in an enterprise from a set of one or more project data sources;
performing, by the computer, an analysis of the IT project data corresponding to the plurality of IT projects using natural language processing and machine learning; and
determining, by the computer, project release date, project status, project priority, project position, and project features for each IT project in the plurality of IT projects based on the analysis.

3. The computer-implemented method of claim 2 further comprising:
selecting, by the computer, an IT project in the cross-project dependency risk chart;
incrementing, by the computer, a size of a node representing the selected IT project by one unit of size for each dependent IT project that corresponds to the selected IT project;
applying, by the computer, a project status indicator to the node representing the selected IT project based on the determined project status of the selected IT project;
applying, by the computer, a project priority indicator to the node representing the selected IT project based on the determined project business priority of the selected IT project; and
listing, by the computer, only specific project features that will be reused in dependent projects within the node representing the selected IT project when not all of the determined project features of the selected IT project will be reused in dependent projects.

4. The computer-implemented method of claim 1 further comprising:
applying, by the computer, a corresponding project release date proximity risk indicator to each line representing a respective cross-project dependency in the cross-project dependency risk chart based on whether a respective dependent IT project is in a same release date, a next release date, or a further subsequent release date as the IT project the respective dependent IT project depends on.

5. The computer-implemented method of claim 1 further comprising:
applying, by the computer, a stacked dependency indicator to any IT project node that has a plurality of cross-project dependencies in the cross-project dependency risk chart.

6. The computer-implemented method of claim 1 further comprising:
performing, by the computer, an analysis the cross-project dependency risk chart using machine learning;
determining, by the computer, whether one or more IT projects are at risk of not making a corresponding release date based on the analysis of the cross-project dependency risk chart; and
responsive to the computer determining that one or more IT projects are at risk of not making a corresponding release date based on the analysis of the cross-project dependency risk chart, performing, by the computer, a set of mitigation action steps corresponding to the one or more IT projects at risk of not making their corresponding release dates.

7. The computer-implemented method of claim 1 further comprising:
receiving, by the computer, an input selecting a node corresponding to an IT project that has one or more dependencies in the cross-project dependency risk chart; and
responsive to the computer receiving the input, outputting, by the computer, a secondary project dependency chart that focuses only on the selected IT project with details regarding the one or more dependencies, scope of the one or more dependencies, features of the one or more dependencies that will be reused in the selected IT project, and test scenarios ensuring that reused features will fulfill the selected IT project's scope.

8. The computer-implemented method of claim 1 further comprising:
receiving, by the computer, an input moving a node corresponding to an IT project that has one or more dependent IT projects from a first release date to a second release date in the cross-project dependency risk chart; and
modifying, by the computer, project release date proximity risk indicators corresponding to the one or more dependent IT projects based on the input moving the node to the second release date.

9. A computer system for managing cross-project dependencies, the computer system comprising:
a bus system;
a storage device connected to the bus system, wherein the storage device stores program instructions; and
a processor connected to the bus system, wherein the processor executes the program instructions to:
generate a list of Information Technology (IT) projects and their corresponding dependent IT projects;
generate a cross-project dependency risk chart having an X-axis based on IT project release dates and a Y-axis based on IT project positions;
plot each IT project, along with its corresponding set of dependent IT projects from the list, on the X-axis of the cross-project dependency risk chart based on determined project release dates and on the Y-axis of the cross-project dependency risk chart based on determined project positions;
insert a line representing cross-project dependency between each dependent IT project and an IT project that a respective dependent IT project depends on with an arrow pointing to the IT project that the respective dependent IT project depends on; and
output the cross-project dependency risk chart on a display device.

10. The computer system of claim 9, wherein the processor further executes the program instructions to:
retrieve IT project data corresponding to a plurality of IT projects currently under development in an enterprise from a set of one or more project data sources;
perform an analysis of the IT project data corresponding to the plurality of IT projects using natural language processing and machine learning; and
determine project release date, project status, project priority, project position, and project features for each IT project in the plurality of IT projects based on the analysis.

11. The computer system of claim 10, wherein the processor further executes the program instructions to:
select an IT project in the cross-project dependency risk chart;
increment a size of a node representing the selected IT project by one unit of size for each dependent IT project that corresponds to the selected IT project;
apply a project status indicator to the node representing the selected IT project based on the determined project status of the selected IT project;
apply a project priority indicator to the node representing the selected IT project based on the determined project business priority of the selected IT project; and
list only specific project features that will be reused in dependent projects within the node representing the selected IT project when not all of the determined project features of the selected IT project will be reused in dependent projects.

12. The computer system of claim 9, wherein the processor further executes the program instructions to:
apply a corresponding project release date proximity risk indicator to each line representing a respective cross-project dependency in the cross-project dependency risk chart based on whether a respective dependent IT project is in a same release date, a next release date, or a further subsequent release date as the IT project the respective dependent IT project depends on.

13. A computer program product for managing cross-project dependencies, the computer program product comprising a computer readable storage medium having program instructions embodied therewith, the program instructions executable by a computer to cause the computer to perform a method comprising:
generating, by the computer, a list of Information Technology (IT) projects and their corresponding dependent IT projects;
generating, by the computer, a cross-project dependency risk chart having an X-axis based on IT project release dates and a Y-axis based on IT project positions;
plotting, by the computer, each IT project, along with its corresponding set of dependent IT projects from the list, on the X-axis of the cross-project dependency risk chart based on determined project release dates and on the Y-axis of the cross-project dependency risk chart based on determined project positions;
inserting, by the computer, a line representing cross-project dependency between each dependent IT project and an IT project that a respective dependent IT project depends on with an arrow pointing to the IT project that the respective dependent IT project depends on; and
outputting, by the computer, the cross-project dependency risk chart on a display device.

14. The computer program product of claim 13 further comprising:
retrieving, by the computer, IT project data corresponding to a plurality of IT projects currently under development in an enterprise from a set of one or more project data sources;
performing, by the computer, an analysis of the IT project data corresponding to the plurality of IT projects using natural language processing and machine learning; and
determining, by the computer, project release date, project status, project priority, project position, and project features for each IT project in the plurality of IT projects based on the analysis.

15. The computer program product of claim 14 further comprising:
selecting, by the computer, an IT project in the cross-project dependency risk chart;
incrementing, by the computer, a size of a node representing the selected IT project by one unit of size for each dependent IT project that corresponds to the selected IT project;
applying, by the computer, a project status indicator to the node representing the selected IT project based on the determined project status of the selected IT project;
applying, by the computer, a project priority indicator to the node representing the selected IT project based on the determined project business priority of the selected IT project; and
listing, by the computer, only specific project features that will be reused in dependent projects within the node representing the selected IT project when not all of the determined project features of the selected IT project will be reused in dependent projects.

16. The computer program product of claim 13 further comprising:
applying, by the computer, a corresponding project release date proximity risk indicator to each line representing a respective cross-project dependency in the cross-project dependency risk chart based on whether a respective dependent IT project is in a same release date, a next release date, or a further subsequent release date as the IT project the respective dependent IT project depends on.

17. The computer program product of claim 13 further comprising:
applying, by the computer, a stacked dependency indicator to any IT project node that has a plurality of cross-project dependencies in the cross-project dependency risk chart.

18. The computer program product of claim 13 further comprising:
performing, by the computer, an analysis the cross-project dependency risk chart using machine learning;
determining, by the computer, whether one or more IT projects are at risk of not making a corresponding release date based on the analysis of the cross-project dependency risk chart; and
responsive to the computer determining that one or more IT projects are at risk of not making a corresponding release date based on the analysis of the cross-project dependency risk chart, performing, by the computer, a set of mitigation action steps corresponding to the one or more IT projects at risk of not making their corresponding release dates.

19. The computer program product of claim 13 further comprising:
receiving, by the computer, an input selecting a node corresponding to an IT project that has one or more dependencies in the cross-project dependency risk chart; and
responsive to the computer receiving the input, outputting, by the computer, a secondary project dependency chart that focuses only on the selected IT project with details regarding the one or more dependencies, scope of the one or more dependencies, features of the one or more dependencies that will be reused in the selected IT project, and test scenarios ensuring that reused features will fulfill the selected IT project's scope.

20. The computer program product of claim 13 further comprising:
receiving, by the computer, an input moving a node corresponding to an IT project that has one or more dependent IT projects from a first release date to a second release date in the cross-project dependency risk chart; and
modifying, by the computer, project release date proximity risk indicators corresponding to the one or more dependent IT projects based on the input moving the node to the second release date.
